(19) United States
(12) Patent Application Publication
(10) Pub. No.: US 2025/0010260 A1
(43) Pub. Date: Jan. 9, 2025

(54) IMPROVING THE ENERGY EFFICIENCY OF A PROCESS AND PLANT FOR PRODUCING HYDROGEN

(71) Applicant: Topsoe A/S, Kgs. Lyngby (DK)

(72) Inventors: Steffen Spangsberg CHRISTENSEN, Køge (DK); Christian WIX, Nærum (DK)

(73) Assignee: Topsoe A/S, Kgs. Lyngby (DK)

(21) Appl. No.: 18/708,369

(22) PCT Filed: Nov. 22, 2022
(86) PCT No.: PCT/EP2022/082733

§ 371 Date: May 8, 2024

(30) Foreign Application Priority Data
Nov. 26, 2021 (DK) PA 2021 01126

(51) Int. Cl. B01J 8/06; B01D 53/14; B01D 53/18; B01D 53/62; B01D 53/78; B01D 53/96; C01B 3/48; C01B 3/52

(52) U.S. Cl. CPC B01J 8/067; B01D 53/1425; B01D 53/1475; B01D 53/1493; B01D 53/18; B01D 53/62; B01D 53/78; B01D 53/96; B01J 8/065; C01B 3/48; C01B 3/52; B01D 2252/204; B01D 2256/16; B01D 2257/504; B01J 2208/065; C01B 2203/0233; C01B 2203/0283; C01B 2203/0415; C01B 2203/0475; C01B 2203/0811; C01B 2203/1241

(57) ABSTRACT

A plant and process for producing hydrogen, comprising: a primary reforming unit arranged to receive a hydrocarbon feed, such as natural gas, and comprising: a combustion section comprising a catalyst suitably for steam methane reforming, and one or more burners for providing heat for said steam methane reforming, for thereby generating a synthesis gas stream and a flue gas stream, and a convection section comprising heat exchangers for thereby generating a cooled flue gas stream; wherein said one or more burners are arranged to receive a preheated combustion air stream and a preheated fuel gas stream derived from a downstream hydrogen purification unit which is arranged to receive at least a portion of said synthesis gas stream, for thereby generating a hydrogen-rich stream and an off-gas stream; and in which the fuel gas stream is a portion of said hydrogen-rich stream i.e. first fuel gas stream, or a gas stream, i.e. second fuel gas stream, resulting from combining at least a portion of said off-gas stream and a portion of said hydrogen-rich stream. The invention relates also to method of retrofitting an existing plant for producing hydrogen.

### FIELD OF THE INVENTION

The present invention relates to a plant and process for producing hydrogen, as well as a method of retrofitting an existing plant for producing hydrogen. The plant and process utilize a primary reforming unit, such as a steam methane reforming unit (SMR), which comprises a combustion section having arranged therein catalyst filled tubes and burners for providing heat to the steam methane reforming, thereby generating a flue gas and a synthesis gas. The primary reforming unit comprises also a convection section for cooling the flue gas by means of a first set of heat exchangers. The synthesis gas is converted to hydrogen by conducting the synthesis gas to a hydrogen purification unit, such as a pressure swing adsorption unit (PSA unit), for generating a hydrogen-rich gas and an off-gas. A first fuel gas being a portion of the hydrogen-rich gas, or a second fuel gas being a mixture of the first fuel gas and the off-gas, is used as fuel for the burners of the primary reforming unit. The fuel gas is free of sulfur, thereby enabling cooling the flue gas from the primary reforming to lower temperatures without risking sulfuric acid condensation and resulting corrosion problems, thereby also enabling to extract more heat duty which can be used for preheating of streams in the plant or process. The use of import fuel for the burners, such as natural gas, is also significantly reduced or eliminated, thereby improving the energy efficiency of the plant.

The present invention relates also to a method of retrofitting a plant for producing hydrogen.

### BACKGROUND OF THE INVENTION

In conventional plants for producing hydrogen, a hydrocarbon feed gas, typically natural gas is desulfurized and converted into a synthesis gas i.e. a gas containing carbon oxides (CO, CO₂) and hydrogen by prereforming and subsequent steam methane reforming. The resulting synthesis gas is then enriched in hydrogen by water gas shift according to the exothermic reaction CO+H₂ [symbol] CO₂+H₂, followed by carbon dioxide removing step in a CO₂-removal section such as an amine wash unit, and the synthesis gas is finally purified into a hydrogen-rich stream in a hydrogen purification unit such as a pressure swing adsorption unit (PSA unit). The PSA unit generates also a PSA off-gas stream which contains methane, hydrogen as well as carbon oxides. In a conventional steam methane reforming unit (SMR, also known as tubular reformer), steam methane reforming according to the endothermic reaction CH₄+H₂O [symbol] CO+3H₂ is conducted at 700-1000° C. in a plurality of catalyst filled tubes provided in the combustion section of the SMR and where the heat needed is provided by several burners arranged therein. The fuel to the burners is typically provided by importing natural gas. Flue gas from the burning is generated at high temperatures, e.g. at around 1000° C., and is used typically to preheat the hydrocarbon feed, e.g. natural gas or prereformed natural gas, as well as to preheat the combustion air used in the burners.

Typically also, the flue gas after delivering heat needs to be at a temperature high enough to avoid reaching the dew point of sulfuric acid, which is 138° C. or higher depending on the sulfur, more specifically sulfur trioxide, content of the flue gas. If the temperature decreases below this level, condensation of sulfuric acid in any equipment in contact with this gas will suffer of highly undesirable corrosion problems.

EP 2103569 A2 discloses a process for generating hydrogen and/or synthesis gas by steam-hydrocarbon reforming along with generating steam using waste heat from the steam-hydrocarbon reforming process, in which the process generates little or no steam export. FIG. 1 therein discloses residual gas from a pressure swing adsorption (PSA), i.e. PSA-off gas, being combined with a hydrocarbon feedstock and hydrogen, supplied to an optional sulfur removal unit and then to a an optional prereformer before being introduced to a steam methane reformer. This citation is dedicated to the problem of eliminating steam export and is silent on how to mitigate the issue of condensing sulfuric acid when wanting to extract duty from the flue gas of a primary reforming unit such as an SMR in a plant or process for producing hydrogen. Further, in the citation, a supplemental fuel such as natural gas is added to the reformer, and no hydrogen from the PSA is used as fuel in the reformer.

EP 3573925 A1 (WO18140686 A1) discloses a system and method to mitigate the above-mentioned problem of condensation of sulfuric acid in any equipment in contact with the flue gas. The system includes an desulfurization unit for removing sulfur from a natural gas, a portion of which is then used as fuel gas, a pre-reformer for converting heavy hydrocarbons in the other portion of the desulfurized natural gas (process gas stream) to methane, a steam methane reformer for producing a synthesis gas and a flue gas, a PSA unit for producing a product hydrogen stream and a PSA off-gas stream, and an air preheater for cooling the flue gas against a combustion air and the PSA off-gas to a temperature below the dew point of sulfuric acid. Import of natural gas for use as fuel is required as so is the need of conducting a step for removing its sulfur content, thus conveying a penalty in terms of natural gas consumption and energy efficiency of the plant, as well as a larger desulfurization unit e.g. sulfur absorber and attendant sulfur adsorbing material, thereby resulting in higher capital and operating expenses.

### SUMMARY OF THE INVENTION

It is an object of the present invention to provide an alternative and superior way, i.e. providing higher energy efficiency and less capital and operating expenses, of mitigating the issue of condensing sulfuric acid when wanting to extract duty from the flue gas of a primary reforming unit such as an SMR in a plant or process for producing hydrogen.

It is another object of the present invention to provide a plant or process for producing hydrogen which is capable of capturing about 90% of the carbon dioxide generated in the plant, while at the same time providing for high plant or process integration.

It is another object of the present invention to provide a simple method of retrofitting an existing plant for producing hydrogen which uses a primary reforming unit for generating synthesis gas, whereby the energy efficiency of the plant is significantly increased.

These and other objects are solved by the present invention.

Accordingly, in a first aspect the invention provides a plant for producing hydrogen, comprising:
a primary reforming unit arranged to receive a hydrocarbon feed, such as natural gas, and comprising:
   a combustion section comprising a catalyst suitable for steam methane reforming, and one or more burners for providing heat for said steam methane reforming, for thereby generating a first synthesis gas stream and a flue gas stream, and
   a convection section comprising a first set of heat exchangers for thereby generating a cooled flue gas stream;
a downstream hydrogen purification unit arranged to receive at least a portion of said first synthesis gas stream, for thereby generating a hydrogen-rich stream and an off-gas stream, said downstream hydrogen purification unit being provided with an outlet for withdrawing said hydrogen-rich stream and an outlet for withdrawing said off-gas stream; a splitting point, such as stream splitter, arranged to divide a portion of said hydrogen-rich stream as a first fuel gas stream; a mixing point, such as a juncture or mixing unit, arranged to receive and combine at least a portion of said off-gas stream with said first fuel gas stream, and to provide a second fuel gas stream resulting from combining said off-gas stream with said first fuel gas stream;
wherein said one or more burners are arranged to receive a preheated combustion air stream and: a preheated first fuel gas stream or a preheated second fuel gas stream;

In an embodiment, the plant is arranged to receive only said first fuel gas stream or second fuel gas stream as fuel to said one or more burners. Accordingly, the plant is absent of means, such as a conduit, for providing a separate fuel gas stream, such as natural gas stream or desulfurized natural gas stream, to said one or more burners.

Thereby it is now possible to stop or significantly reduce the use of import fuel (natural gas) for the burners, and instead, using hydrogen produced in the plant as supplementary fuel, suitably together with off-gas from the hydrogen purification unit. The new fuel gas, for instance the second fuel gas stream which combines the off-gas and hydrogen (hydrogen-rich stream), does not contain any sulfur, so it is now possible to cool the flue gas in the primary reforming unit to a lower temperature without risking condensation of sulfuric acid. Furthermore, by reducing or eliminating the use of import fuel for the burners, such as natural gas, improved energy efficiency of the plant and process is achieved. The plant being absent of a means, such as a conduit, for providing a separate fuel gas stream such as natural gas stream or desulfurized natural gas stream to said one or more burners, further enables less piping requirements and attendant costs: there is no need of increasing costs for providing additional natural gas and thereby inducing higher energy consumption. Furthermore, the desulfurization unit upstream the primary reforming can be made smaller, as the natural gas fed to this unit is only the natural gas used as process gas in the primary reforming unit, not a larger natural gas stream also envisaging its use as fuel gas for the burners.

For the purposes of the present application, the term “comprising” includes also “comprising only” i.e. “consisting of”.

The term “first aspect of the invention” or simply “first aspect” relates to the process of the invention; the term “second aspect of the invention” refers to the plant for carrying out the process, and the term “third aspect of the invention” refers to the method of retrofitting a plant for producing hydrogen, i.e. method of retrofitting an existing hydrogen plant.

The term “present invention” or simply “invention” may be used interchangeably with the term “present application” or simply “application”.

The term “suitably” may be used interchangeably with the term “optionally”, i.e. an optional embodiment.

The term “catalyst suitable for steam methane reforming” means “steam reforming catalyst”.

The term “juncture” and “junction” are used interchangeably.

Other definitions are provided in connection with one or more embodiments of the invention.

In an embodiment according to the first aspect of the invention, said primary reforming unit is a fired steam methane reformer (SMR), said combustion section being arranged to accommodate a plurality of catalyst filled tubes suitable for the steam methane reforming, thereby generating said first synthesis gas stream and said flue gas stream; said convection section being arranged downstream said combustion section and arranged to receive said flue gas stream and to accommodate said first set of heat exchangers, suitably a plurality of heat exchangers arranged in series such as heating coils arranged in series, thereby generating said cooled flue gas stream; said primary reforming unit being provided with an outlet for withdrawing said first synthesis gas stream and an outlet for withdrawing said cooled flue gas stream.

It would be understood that the term, “convection section being arranged downstream said combustion section” is with respect to the flow direction of the flue gas generated in the combustion section of the SMR.

In an embodiment according to the first aspect of the invention, the first set of heat exchangers comprises:
a heat exchanger arranged to receive combustion air for generating said preheated combustion air;
a heat exchanger arranged to receive at least a portion of said first or second fuel gas stream for generating said preheated first fuel gas stream or said preheated second fuel gas stream.

Suitably, the heat exchanger is provided as a coil arranged in the convection section, through which the combustion air, or the fuel gas stream i.e. first or second fuel gas stream, passes. The additional duty (heat duty) resulting from incorporating the first or second fuel gas streams enables preheating of these, or any other feed streams to the e.g. primary reforming unit.

Suitably, the first set of heat exchangers also comprises additional heat exchangers, for instance a boiler for producing steam against the flue gas.

Suitably, said preheated combustion air is generated in a heat exchanger of said first set of heat exchangers, such as in the heat exchanger arranged upstream the most downstream heat exchanger thereof.

In an embodiment according to the first aspect of the invention, the plant further comprises:
a shift section arranged to receive at least a portion of said first synthesis gas stream, thereby generating a second synthesis gas stream;
a CO₂-removal section, the CO₂-removal section suitably being a chemical absorption unit where a solvent solution needs regeneration by heating, suitably a solvent wash unit, such as an amine wash unit, arranged to receive said second synthesis gas stream and comprising a CO₂-absorber under the addition of the solvent solution, suitably an amine solution, and a CO₂-stripper for regenerating the solvent solution, e.g. the amine solution, thereby generating a third synthesis gas stream and a first CO₂-rich stream;
said hydrogen purification unit arranged to receive at least a portion of said first, second or third synthesis gas stream, thereby generating said hydrogen-rich stream and said off-gas stream.

Thereby it is possible to enrich the synthesis gas in hydrogen and remove its carbon dioxide content prior to the shifted, i.e. third synthesis gas stream, entering the hydrogen purification unit. The CO₂-rich stream may then e.g. be safely stored, thereby reducing the carbon footprint of the plant and process.

In an embodiment according to the first aspect of the invention,
said convection section comprises a second set of heat exchangers, in which said second set of heat exchangers is arranged to:
i) receive a portion of said first or second fuel gas stream, thereby generating a further cooled flue gas stream, and a preheated first fuel gas stream or a preheated second fuel gas stream; or
ii) receive a solvent solution, e.g. an amine-solution, from: said solvent wash unit, e.g. said amine wash unit, thereby generating a further cooled flue gas stream and a preheated solvent-solution, e.g. a preheated amine-solution; or
iii) receive boiling feed water (BFW) and/or demineralized water (DMW) which is used in said plant for producing hydrogen, thereby generating a further cooled flue gas stream as well as steam and/or preheated DMW; or
iv) receive the hydrocarbon feed, thereby generating a further cooled flue gas stream as well as a preheated hydrocarbon feed.

The provision of the plant incorporating the new fuel gas stream, e.g. the second fuel gas combining the off-gas and hydrogen i.e. hydrogen-rich stream from the hydrogen purification unit, makes it possible to add an additional heat exchanger, suitably a preheating coil, in the convection section of the primary reforming unit to extract more duty, thereby enhancing the efficiency of the plant. This duty can be used for i.a. preheating a fuel gas stream, preheating of the solvent solution e.g. amine solution from the amine wash unit, preheating DMW/BFW, or preheating the hydrocarbon feed stream.

It would be understood that the term “DMW/BFW” means demineralized water and/or boiling feed water.

It would also be understood that for the purposes of the present application, the term “and/or” means one of the options or a combination of the options. For instance, DMW and/or BFW means DMW, BFW or a combination thereof.

The duty can also be used in a CO₂-reboiler of a CO₂-removal section arranged downstream said convection section of the primary reforming unit as a flue gas-CO₂-removal section. The thus captured CO₂ from the flue gas may then be safely stored. This removal section is also referred to as “post carbon capture removal unit”.

The CO₂-stripper of a CO₂-removal section, either when the latter is arranged for capturing CO₂ in the process gas, more specifically the synthesis gas downstream the primary reforming unit, or when arranged for capturing CO₂ in the flue gas from said primary reforming unit (post carbon capture removal unit), is normally provided with a reboiler and a feed/effluent heat exchanger for pre-heating the solvent solution e.g. the amine solution. The additional duty provided by the invention may be further utilized by arranging a preheater coil e.g. an amine preheater coil, downstream said feed/effluent heat exchanger, or as an additional reboiler in the CO₂-stripper. Hence, the invention enables i.a. preheating of e.g. the amine solution in a CO₂-removal section of the plant, and providing duty for driving e.g. the post carbon capture removal unit. This further enables reduced energy waste and thus results in increased energy efficiency of the plant.

In a particular embodiment, said second set of heat exchangers comprises one or more heat exchangers, suitably one heat exchanger, arranged downstream said first set of heat exchangers. The heat exchanger is suitably provided as a coil, as is also the case in connection with the first set of heat exchangers.

Hence, a second heat exchanger set is suitably provided in the convection section, also referred to as flue-gas section, of the primary reforming unit to extract more duty enabling thereby, along with the stop of the use of natural gas as external fuel source, a higher energy efficiency of the plant—and process. The low temperature of the cooled flue gas at, e.g. 110-120° C., is advantageously utilized.

For instance, in connection with i) a portion of the first or second fuel gas stream, instead of its entirety being preheated in a heat exchanger of the first set of heat exchangers, it is suitably fed to a heat exchanger of the second set of heat exchangers. The preheated fuel gas stream from the latter, which suitably is arranged downstream the heat exchanger of the first set, is also sent to a heat exchanger of the first set before feeding it as preheated fuel gas stream to the burners.

In connection with ii), in an e.g. amine-wash unit, as is well known in the art, the CO₂-stripper (also referred to as desorber) comprises a so-called CO₂-reboiler at the bottom, where a stream derived from the bottom of the CO₂-stripper and comprising amine is heated for thereby removing CO₂ from the amine. Normally, an amine solution (lean amine-solution) is withdrawn as a bottom product of the CO₂-stripper. The bottom product then delivers heat in an amine preheater (feed/effluent heat exchanger) to an amine solution (rich amine-solution) withdrawn from the bottom of upstream CO₂-absorber and which after being preheated is fed to the CO₂-stripper, normally to the top of the CO₂-stripper. After delivering heat in the amine preheater, the amine solution (lean amine-solution) withdrawn from the bottom of the CO₂-stripper is fed to the top of the CO₂-absorber. By an embodiment of the invention, said second set of heat exchangers, suitably a heat exchanger arranged downstream the first set, functions instead as an ammine preheater suitably arranged downstream the feed/effluent heat exchanger, which thereby extracts additional duty from the flue gas, thus also enabling less duty in the CO₂-reboiler of the CO₂-stripper. The provision of a CO₂-reboiler smaller in size is thereby also possible. Further, the need of using e.g. steam, more specifically low-pressure steam, for driving the CO₂-reboiler, as is often the case, is also reduced. Moreover, higher integration in the plant or process is achieved by directly fluid-communicating the amine wash unit with the convection section of the primary reforming unit, as the amine-solution (rich amine-solution) runs through the heat exchanger arranged therein, e.g. through a coil, against cooled flue gas travelling through the convection section. The cooled flue gas from the first set of heat exchangers, being for instance at 120° C., delivers heat to the amine-solution (rich amine-solution) so it is preheated to e.g. 150-110° C., suitably after the feed/effluent heat exchanger, prior to entering the top of the CO₂-stripper.

In the amine wash unit, the CO₂-absorber operates suitably in the temperature range 30-50° C., and pressure range 1-200 atm abs., while the CO₂-stripper operates suitably in the temperature range 110-130° C. and 1.2-2 atm abs. at the bottom of the CO₂-stripper.

As mentioned, a post carbon capture-removal unit may be provided. Accordingly, an additional solvent wash unit, suitably an amine wash unit for removing CO₂ from the flue gas, also comprising a CO₂-absorber and CO₂-stripper with attendant CO₂-reboiler, may be provided. For instance, in connection with the above recited embodiment ii), an amine preheater is also suitably used for preheating an amine solution from this additional amine wash unit. Thus, in embodiment ii) said second set of heat exchangers may also be arranged to receive a solvent solution, e.g. an amine-solution, from: from an additional CO₂-removal section which is arranged downstream said convection section of the primary reforming unit, suitably an additional solvent wash unit, e.g. an additional amine wash unit; thereby generating a further cooled flue gas stream and a preheated solvent-solution, e.g. a preheated amine-solution.

Suitably also, another heat exchanger, e.g. a coil, may be arranged in parallel in the convection section, and used as amine preheater for said additional amine wash unit.

Now, more specifically, in an embodiment according to the first aspect of the invention, the plant further comprises an additional CO₂-removal section arranged to receive said cooled flue gas stream or said further cooled flue gas stream, thereby generating a second CO₂-rich stream and a CO₂-depleted flue gas stream, and in which said additional CO₂-removal section also comprises a CO₂-absorber under the addition of a solvent solution and a CO₂-stripper for regenerating the solvent solution.

Thereby, CO₂ emissions from the hydrogen plant can be reduced by 90% or more, thus drastically further reducing the carbon-footprint of the plant. Heretofore, there have not been developed standard solutions for capturing CO₂ from the flue gas of a primary reforming unit, particularly an SMR, in a plant for producing hydrogen.

By combining this additional CO₂-removal/capture section (post-CO₂-capture) with the CO₂-removal/capture section downstream the water gas shift section (pre-CO₂-capture), the above mentioned percentage reduction in CO₂ emissions is achieved, while at the same time further integrating the additional duty (heat duty) available in the flue gas with the additional CO₂-removal/capture section by means of said preheating of the amine solution used therein, i.e. amine-rich solution, by the cooled flue gas of the primary reforming unit. The post-CO₂-capture acts thereby also synergistically with the rest of the plant for producing hydrogen. The CO₂ from pre-CO₂-capture and post-CO₂ capture is then suitably transported for e.g. sequestration in geological structures.

In connection with the above-recited embodiment iii), it would be understood that BFW as well as DMW are imported streams in the plant. Normally, the BFW will go to a steam drum and from there, a stream is withdrawn which is used for cooling a synthesis gas stream. Normally also, DMW for use in the plant is preheated by cooling a synthesis gas stream, suitably the synthesis gas stream generated after water gas shift yet prior to a process gas (here synthesis gas) air cooler, where the temperature of the synthesis gas is around 120-130° C. Additional duty is extracted from the cooled flue gas instead, as its temperature is also around this range.

As recited above, the heat exchanger of the second set of heat exchangers is suitably provided as a coil. Accordingly, in an embodiment, the portion the fuel gas in i), or the solvent solution in ii), or the BFW or DMW in iii), runs inside the coil against the flue gas stream, more specifically the cooled flue gas stream.

In an embodiment according to the first aspect, said shift section comprises a high temperature shift (HTS). In another embodiment, the shift section comprises one or more additional high temperature shift units in series. In yet another embodiment, said shift section further comprises one or more additional shift units downstream the HTS unit, wherein the one or more additional shift units are one or more medium temperature shift (MTS) units and/or one or more low temperature shift (LTS) units. As is well-known in the art, in the shift section, the syngas is enriched in hydrogen by conducting the water gas shift reaction CO+H₂=CO₂+H₂, as already recited farther above.

In an embodiment according to the first aspect of the invention, the plant further comprises one or more prereforming units (prereformers) arranged upstream said primary reforming unit and arranged to receive said hydrocarbon feed, such as natural gas e.g. desulfurized natural gas.

Hence, it would be understood that said hydrocarbon feed may also be a pre-reformed hydrocarbon feed. As is well-known in the art, in a pre-reformer all higher hydrocarbons can be converted to carbon oxides and methane, thus resulting in a higher methane content of the gas being fed to the primary reforming unit.

In an embodiment according to the first aspect of the invention, the hydrogen purification unit is a Pressure Swing Adsorption unit (PSA unit).

As is well-known in the art, PSA is a noncryogenic air separation process that is commonly used in commercial practice, and which involves the adsorption of the synthesis gas by adsorbents such as zeolite and silica in a high-pressure gas column, thereby generating a hydrogen-rich gas of high purity, e.g. 99.9 wt % or more H₂. From the PSA unit, the off-gas stream is for instance delivered at about 30-40° C., while the hydrogen-rich gas stream is for instance delivered at about 40-50° C.

It is also envisaged the use of additional hydrogen purification units, suitably also a second PSA unit, which may be provided to receive a portion of the off-gas from the first PSA unit, for thereby generating a second off-gas stream and a second hydrogen-rich gas stream. The off-gas streams from both PSA-units may be combined into a single off-gas stream, and the hydrogen-rich streams may also be combined into a single hydrogen-rich stream.

In a second aspect, the invention provides a process for producing hydrogen, the process comprising:
providing a plant according to any of the embodiments according to the first aspect of the invention;
conducting a primary reforming step of a hydrocarbon feed by supplying said hydrocarbon feed, such as natural gas, to a primary reforming unit including a combustion section comprising a catalyst suitable for steam methane reforming and one or more burners for providing heat for said steam methane reforming, and conducting under the presence of steam said steam methane reforming for generating a first synthesis gas stream and a flue gas stream; said primary reforming unit also including a convection section comprising a first set of heat exchangers and cooling the flue gas stream in said first set of heat exchangers for generating a cooled flue gas stream;
optionally, conducting water gas shift by supplying the first synthesis gas to a shift section arranged to receive at least a portion of said first synthesis gas stream, said shift section suitably comprising a high temperature shift (HTS), for generating a second synthesis gas stream;
optionally, removing CO₂ from the second synthesis gas by supplying the first or second synthesis gas stream to a CO₂-removal section, the CO₂ removal section being a chemical absorption unit where a solvent solution needs regeneration by heating, suitably a solvent wash unit, such as an amine wash unit, arranged to receive said first or second synthesis gas stream and comprising a CO₂-absorber under the addition of a solvent solution, e.g. an amine solution, and regenerating the solvent solution, e.g. amine solution, in a CO₂-stripper, for generating a third synthesis gas stream as well as a first CO₂-rich stream;
supplying to said one or more burners a preheated combustion air stream;
supplying to said one or more burners a preheated first fuel gas stream or a preheated second fuel gas stream, in which the first fuel gas stream is a portion of said hydrogen-rich stream, and the second fuel gas stream is a gas stream resulting from combining at least a portion of said off-gas stream and said first fuel gas stream i.e. said portion of said hydrogen-rich stream.

In an embodiment according to the second aspect of the invention, the process further comprises only supplying said first fuel gas stream or second fuel gas stream as fuel to said one or more burners. Accordingly, the process does not comprise supplying a separate fuel gas stream such as natural gas stream or desulfurized natural gas stream to said one or more burners.

In an embodiment according to the second aspect of the invention,
said preheated combustion air stream, or said preheated first or second fuel gas stream, i.e. the preheating of the combustion air, or first fuel gas, or second fuel gas, is generated by cooling the flue gas in: a heat exchanger of said first set of heat exchangers, and which is being supplied with a combustion air stream, i.e. a cold combustion air stream; or in a heat exchanger of said first set of heat exchangers which is being supplied with said first or second fuel gas stream.

In an embodiment according to the second aspect of the invention, the flue gas is cooled to below 100° C., for instance about 70° C. Normally the flue gas is cooled down to 120-130° C., yet with much less or no sulfur in the flue gas, it is possible to cool it below 100° C., for instance about 70° C. which is the saturation point for water. Hence, in a particular embodiment, the flue gas is cooled to a temperature in the range 70-99° C., such as 75, 80, 85 or 95° C.

In an embodiment according to the second aspect of the invention, the process further comprises providing said convection section with a second set of heat exchangers, suitably a heat exchanger downstream said first set of heat exchangers, and:
i) supplying a portion of: said first or second fuel gas stream to the second set of heat exchangers, for generating a further cooled flue gas stream and said preheated first or second fuel gas stream, and feeding the preheated first or second fuel gas stream to said one or more burners of the primary reforming unit; or
ii) supplying a solvent solution, e.g. an amine-solution, from
   said solvent wash unit, e.g. amine wash unit, or from
   an additional CO₂-removal section, suitably an additional solvent wash unit, arranged downstream said convection section of the primary reforming unit,
to the second set of heat exchangers, for generating a further cooled flue gas stream and a preheated solvent solution, e.g. a preheated amine-solution; or
iii) supplying boiling feed water (BFW) and/or demineralized water (DMW) which is introduced into said process for producing hydrogen, and supplying BFW and/or DMW to the second set of heat exchangers, for generating a further cooled flue gas stream as well as steam and/or preheated DMW; or
iv) supplying the hydrocarbon feed to the second set of heat exchangers, thereby generating a further cooled flue gas stream as well as a preheated hydrocarbon feed.

It would be understood that said additional CO₂-removal section, suitably an additional solvent wash unit, arranged downstream said convection section of the primary reforming unit, refers to a post carbon capture-removal unit, for thereby removing and capturing CO₂ from the cooled flue gas or from the further cooled flue gas.

In an embodiment according to the second aspect of the invention, the process further comprises prereforming of said hydrocarbon feed in one or more prereforming units (prereformers) arranged upstream said primary reforming unit.

As in connection with the first aspect of the invention (plant), the process of the invention in accordance with the second aspect, enables the incorporation of a new fuel gas stream i.e. other than the hydrocarbon feed, e.g. natural gas, to the hydrogen plant. The new fuel gas stream, suitably being a mixture of PSA off-gas and hydrogen from the PSA, does not contain any sulfur, so that it is now possible to cool the flue gas to a lower temperature without risking condensation of sulfuric acid and resulting corrosion problems. This makes it possible to add an additional preheating coil in the flue gas section (convection section of the primary reforming unit) to extract more duty, thus enhancing the energy efficiency of the plant.

This duty can be used for i.a. preheating of DMW/BFW but also for preheating an amine solution entering the CO₂-stripper of the CO₂-removal section, such as the post carbon capture removal unit (i.e. the additional CO₂-removal section arranged for receiving said further cooled or further cooled flue gas stream). Suitably also, the duty is used in a CO₂ reboiler of the CO₂-stripper of e.g. the post carbon capture removal unit. Thereby, it is now also possible to provide duty for driving the post carbon capture removal unit or for driving the CO₂-removal section arranged between the primary reforming unit and hydrogen purification unit, instead of resorting to the use of low process steam (LP steam) generated in the plant/process or provided as import steam. LP steam is normally used for the CO₂-reboiler. Hence, the invention enables also preheating of e.g. the amine solution in the CO₂-removal section. At least reduced energy consumption and reduced steam consumption is thereby achieved.

Any of the embodiments and associated benefits of the first aspect of the invention (plant) may be used in connection with the second aspect of the invention (process), or vice versa.

In a third aspect, the invention provides a method of retrofitting an existing plant for producing hydrogen which uses a conventional primary reforming unit for generating a synthesis gas.

Accordingly, there is also provided a method of retrofitting a plant for producing hydrogen
said plant comprising a primary reforming unit for producing a synthesis gas stream, and a downstream hydrogen purification unit for producing a hydrogen-rich gas stream and an off-gas stream; the primary reforming comprising: a combustion section comprising a catalyst suitably for steam methane reforming and one or more burners for providing heat for said steam methane reforming, for thereby generating said synthesis gas stream and a flue gas stream, and a convection section comprising a first set of heat exchangers for generating a cooled flue gas stream;
said downstream hydrogen purification unit being provided with an outlet for withdrawing the hydrogen-rich stream and an outlet for withdrawing the off-gas stream;
the method comprising:
   installing in the convection section of the primary reforming unit a second set of heat exchangers, in which said second set of heat exchangers comprises one or more heat exchangers, suitably one heat exchanger, arranged downstream said first set of heat exchangers, thereby generating a further cooled flue gas stream;
   installing a splitting point, such as a stream splitter, for dividing a portion of said hydrogen-rich stream as a first fuel gas stream;
   installing a mixing point, such as a juncture or mixing unit, for combining at least a portion of said off-gas stream with said first fuel gas stream, thus forming a second fuel gas stream; and
   installing a conduit, i.e. a conduct such as a pipe, for conducting said first fuel gas or said second fuel gas stream to the first and/or second set of heat exchangers and further to said one or more burners;
   optionally, installing means for reducing or blocking the supply of a separate fuel gas stream such as natural gas stream or desulfurized natural gas stream to said one or more burners.

Thereby, there is no import of natural gas as external fuel source for the burners. The hydrogen-rich gas stream, or suitably the fuel gas mixture of hydrogen-rich gas and PSA-off gas, is free of sulfur, so it is possible to cool the flue gas to a lower temperature than in the existing primary reforming unit e.g. steam reforming unit without risking condensation of sulfuric acid and resulting corrosion problems. An additional set of heat exchangers, suitably an additional heat exchanger, such as a coil, is installed in the convection section of the reforming unit i.e. flue gas section, preferably downstream the first set of heat exchangers of the existing plant. This enables to extract more duty thereby further enhancing the energy efficiency of the plant.

In an embodiment according to the third aspect of the invention, the plant further comprises a shift section and a CO₂-removal section arranged between the primary reforming unit and hydrogen purification unit, the CO₂-removal section being a chemical absorption unit where a solvent solution needs regeneration by heating, suitably a solvent wash unit, such as an amine wash unit,
the method of retrofitting further comprises:
   installing an additional CO₂-removal section arranged for receiving said cooled or further cooled flue gas stream, i.e. installing a post capture CO₂ removal unit.

In a particular embodiment, the additional CO₂-removal section is an additional chemical absorption unit where a solvent solution needs regeneration by heating, suitably a solvent wash unit, such as an amine wash unit;
the method of retrofitting further comprising
   installing a conduit for providing the solvent-solution e.g. amine solution from said CO₂-removal section arranged between the primary reforming unit and hydrogen purification unit, or from said additional CO₂-removal section arranged for receiving said further cooled flue gas stream, to a heat exchanger of said second set of heat exchangers, thereby generating the further cooled flue gas stream and a preheated solvent solution;
   optionally installing a conduit for providing said preheated solvent solution to the CO₂-stripper of the amine wash unit or the additional amine wash unit.

Thereby it is possible to capture about 90% of the carbon dioxide generated in the plant, while at the same time providing for high plant or process integration.

As in connection with the first or second aspect of the invention, the method of retrofitting enables the incorporation of a new fuel gas stream i.e. other than the hydrocarbon feed, e.g. natural gas, to the existing hydrogen plant. The new fuel gas stream, suitably being a mixture of PSA off-gas and hydrogen (hydrogen-rich gas) from the PSA, does not contain any sulfur, so that it is now possible to cool the flue gas to a lower temperature without risking condensation of sulfuric acid and resulting corrosion problems. This makes it possible to add an additional preheating coil in the flue gas section (convection section of the primary reforming unit) to extract more duty, thus enhancing the energy efficiency of the plant.

This duty can be used for i.a. preheating of DMW/BFW but also for preheating an amine solution entering the CO₂-stripper of the CO₂-removal section, such as the post carbon capture removal unit, i.e. the additional CO₂-removal section arranged for receiving said further cooled or further cooled flue gas stream. Suitably also, the duty is used in a CO₂ reboiler of the CO₂-stripper of e.g. the post carbon capture removal unit. Thereby, it is now also possible to provide duty for driving the post carbon capture removal unit or for driving the CO₂-removal section arranged between the primary reforming unit and hydrogen purification unit, instead of resorting to the use of low process steam (LP steam) generated in the plant/process or provided as import steam. LP steam is normally used for the CO₂-reboiler. Hence, the invention enables also preheating of e.g. the amine solution in the CO₂ removal section. At least reduced energy consumption and reduced steam consumption is thereby achieved.

Any of the embodiments according to the first aspect of the invention (plant) or second aspect of the invention (process) and associated benefits, may be used in connection with the third aspect of the invention (method of retrofitting an existing hydrogen plant), or vice versa.

### BRIEF DESCRIPTION OF THE DRAWINGS

FIG. 1 shows a schematic layout of a plant or process according to the prior art.

FIG. 2 shows a schematic layout of a plant or process according to an embodiment of the present invention.

### DETAILED DESCRIPTION

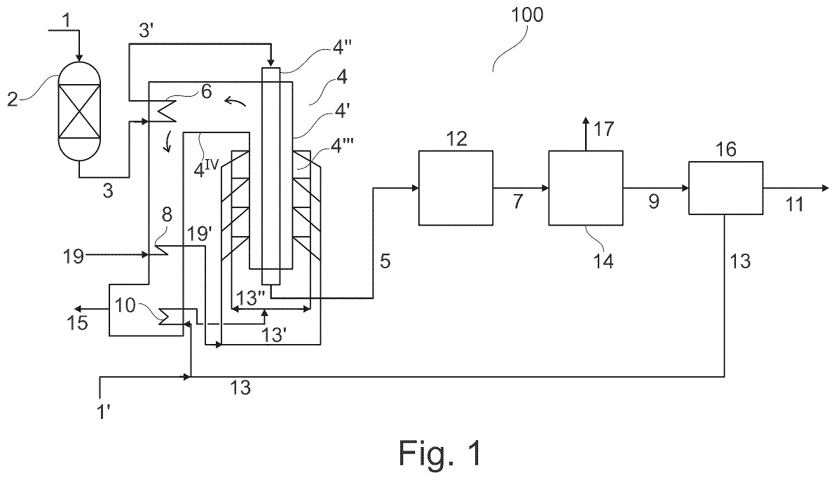

With reference to FIG. 1, a process or plant layout 100 for producing hydrogen according to the prior art is shown. A hydrocarbon feed, here desulfurized natural gas 1, is prereformed in prereforming unit 2 thereby generating a hydrocarbon feed 3 having a higher methane content. The hydrocarbon feed 3 is preheated (stream 3′) in heat exchanger 6, suitably a coil, arranged in the convection section 4^{iv} of primary reforming unit 4, here steam methane reforming unit (SMR). The SMR 4 comprises a combustion section 4′ having one or more catalyst filled tubes 4″ (here for illustration purposes depicted as a single catalyst filled tube) and one or more burners 4′″ arranged therein. The SMR 4 comprises also said convection section 4^{iv} i.e. flue gas section having arranged therein a first set of heat exchangers (coils) 6, 8, 10 along the path of travel of the flue gas generated by the burners as shown by the arrows. For illustration purposes the first set of heat exchangers is shown as comprising only three coils. At the top of the convection section e.g. where the coil 6 is positioned, the temperature is highest, e.g. about 1000° C., whereas in the lower part of the convection section, e.g. where coil 10 is positioned, the temperature is the lowest, e.g. about 120° C. A cooled flue gas 15 is thus withdrawn at the bottom of the convection section.

From the SMR 4 a first synthesis gas stream, here first synthesis gas stream 5 is withdrawn and supplied to water gas shift section 12 comprising a high temperature shift reactor (not shown) and optionally a low or medium temperature shift reactor (not shown), thereby generating a second synthesis gas stream 7 which is enriched in hydrogen. This second synthesis gas stream 7 is then supplied to a CO₂-removal/capture section 14, from which a CO₂-rich gas 17 is withdrawn and a third synthesis gas stream 9 depleted from CO₂ is generated. This third synthesis gas stream 9 is finally supplied to a hydrogen purification unit, suitably a PSA unit 16, thereby generating a hydrogen-rich stream 11 as final product and a PSA off-gas stream 13. The PSA off-gas stream 13 contains some methane and is therefore preheated in coil 10 of the first set of heat exchangers of the convection section 4^{iv} of the SMR 4, or the PSA off-gas 13 is first combined with desulfurized natural gas 1′ before being preheated. The desulfurized natural gas 1′ is suitably a stream which is diverted from desulfurized natural gas stream 1 fed to the prereforming unit 2. The desulfurized natural gas may be also added directly to the burners 4′″. Cold air 19 is provided by an air blower (not shown) and preheated in coil 8 of the first set of heat exchangers, thereby sending a preheated air 19′ together with the preheated PSA off-gas and desulfurized natural gas mixture 13′, 13″, which is free of sulfur, to the burners 4′″.

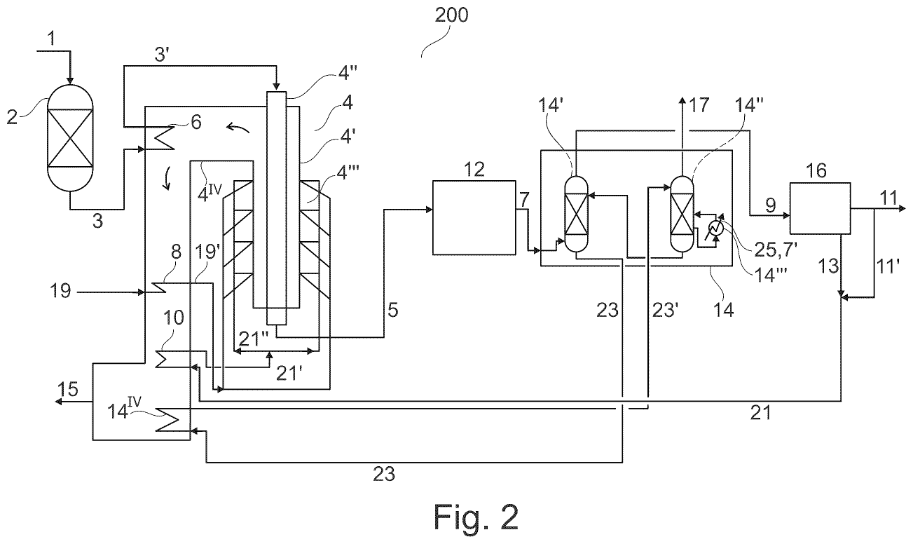

With reference to FIG. 2, an embodiment according to the invention is illustrated. The reference numerals as in FIG. 1 apply, yet the plant 200 for producing hydrogen of FIG. 2 shows now the convection section 4^{iv} of the SMR 4 further comprising a second set of heat exchangers, here a coil 14^{iv}. PSA off-gas 13 is now combined in a mixing point, such as a juncture, i.e. junction, with a portion 11′ being divided in a splitting point, such as stream splitter, in the hydrogen-rich gas stream 11, thereby forming a second fuel gas stream 21, which is free of sulfur. The fuel gas stream 21 is then preheated in coil 10 of the first set of heat exchangers to form preheated fuel gas stream 21′, 21″ and is sent to the burners 4″ together with preheated combustion air 19′. No external import of natural gas as fuel is required, nor is it required to provide a higher amount of natural gas for desulfurization as in in the prior art (FIG. 1).

FIG. 2 includes also the CO₂-removal/capture section 14 as an amine wash unit. The amine wash unit 14 comprises a CO₂-absorber 14′ and a CO₂-stripper (desorber) 14″ with attendant CO₂-reboiler 14′″ which is driven by e.g. low-pressure steam 25 or by second synthesis gas 7′ from the water gas shift section 12 and which has been cooled (not shown). It would be understood, that if cooled synthesis gas 7′ is used to provide heat in the CO₂-reboiler 14′″, the thus further cooled synthesis gas after having delivered heat in the CO₂-reboiler, is suitably fed to the CO₂-absorber 14′ instead of as depicted in the figure where the second synthesis gas stream 7 is supplied directly to the CO₂-absorber 14′. From the top of the CO₂-absorber 14′ a third synthesis gas stream 9 depleted from CO₂ is generated, while at the bottom, an amine solution (amine-rich solution) 23 is withdrawn and preheated in a second set of heat exchangers of the convection section 4^{iv} of the SMR 4, here in heat exchanger (coil) 14^{iv}, and which for instance is provided downstream the last (most downstream) coil 10 of the first set of heat exchangers. The thus preheated amine solution 23′ is then fed to the CO₂-stripper 14″ where the CO₂ is desorbed from the amine, while the amine from the stripper is heated in the CO₂-rebolier 14″″ in order to remove the CO₂ from the amine. Thereby, higher integration of the plant or process is enabled by providing via coil 14^{iv} the required duty in the amine wash unit 14. The CO₂-stripper is normally provided with a feed/effluent heat exchanger (not shown) to preheat with its bottoms stream the amine solution 23′. Suitably, by the invention, the additional duty gained may also be utilized by providing, downstream the feed/effluent heat exchanger, an amine preheater coil (not shown). Hence, more generally, the invention enables i.a. preheating of amine solution in the CO₂-removal section. A splitting point is arranged to divide a portion of said hydrogen-rich stream 11 as a first fuel gas stream 11′; a mixing point is arranged to receive and combine at least a portion of said off-gas stream 13 with said first fuel gas stream 11′, and to provide a second fuel gas stream 21. The one or more burners 4′″ are arranged to receive preheated combustion air 19′ and: preheated first fuel gas stream (not shown) or a preheated second fuel gas stream 21′, 21″. The plant 200 is arranged to receive only said first fuel gas stream 11′ or second fuel gas stream 21′ as fuel to said one or more burners 4′″. The plant 200 is thus absent of means, such as a conduit, for providing a separate fuel gas stream, such as natural gas stream or desulfurized natural gas stream, to the one or more burners. Accordingly, the process does not comprise supplying a separate fuel gas stream such as natural gas stream or desulfurized natural gas stream to the one or more burners.

Similarly, increased energy efficiency is achieved by providing the additional duty of the convection section for driving a post CO₂ capture, i.e. by providing e.g. an additional amine wash unit for removing CO₂ from the further cooled flue gas stream 15.

1. A plant for producing hydrogen, comprising:
a primary reforming unit arranged to receive a hydrocarbon feed and comprising:
a combustion section comprising a catalyst suitable for steam methane reforming, and one or more burners for providing heat for said steam methane reforming, for thereby generating a first synthesis gas stream and a flue gas stream, and
a convection section comprising a first set of heat exchangers for thereby generating a cooled flue gas stream;
a downstream hydrogen purification unit arranged to receive at least a portion of said first synthesis gas stream, for thereby generating a hydrogen-rich stream as said hydrogen and an off-gas stream, said downstream hydrogen purification unit being provided with an outlet for withdrawing said hydrogen-rich stream and an outlet for withdrawing said off-gas stream; a splitting point arranged to divide a portion of said hydrogen-rich stream as a first fuel gas stream; a mixing point arranged to receive and combine at least a portion of said off-gas stream with said first fuel gas stream, and to provide a second fuel gas stream resulting from combining said off-gas stream with said first fuel gas stream;
wherein said one or more burners are arranged to receive a preheated combustion air stream and: a preheated first fuel gas stream or a preheated second fuel gas stream.

2. The plant according to claim 1, wherein the plant is arranged to receive only said first fuel gas stream or second fuel gas stream as fuel to said one or more burners.

3. The plant according to claim 1, wherein:
said a primary reforming unit is a fired steam methane reformer, said combustion section being arranged to accommodate a plurality of catalyst filled tubes suitable for the steam methane reforming, thereby generating said first synthesis gas stream and said flue gas stream; said convection section being arranged downstream said combustion section and arranged to receive said flue gas stream and to accommodate said first set of heat exchangers, suitably a plurality of heat exchangers arranged in series, thereby generating said cooled flue gas stream; said primary reforming unit being provided with an outlet for withdrawing said first synthesis gas stream and an outlet for withdrawing said cooled flue gas stream.

4. The plant according to claim 1, wherein the first set of heat exchangers comprises:
a heat exchanger arranged to receive combustion air for generating said preheated combustion air;
a heat exchanger arranged to receive at least a portion of said first or second fuel gas stream for generating said preheated first fuel gas stream or said preheated second fuel gas stream.

5. The plant according to claim 1, further comprising:
a shift section arranged to receive at least a portion of said first synthesis gas stream, thereby generating a second synthesis gas stream;
a CO2-removal section, the CO2-removal section being a chemical absorption unit where a solvent solution needs regeneration by heating, suitably a solvent wash unit, arranged to receive said second synthesis gas stream and comprising a CO2-absorber under the addition of the solvent solution, suitably an amine solution, and a CO2-stripper for regenerating the solvent solution, e.g. the amine solution, thereby generating a third synthesis gas stream and a first CO2-rich stream;
said hydrogen purification unit arranged to receive at least a portion of said first, second or third synthesis gas stream, thereby generating said hydrogen-rich stream and said off-gas stream.

6. The plant according to claim 1, wherein said convection section comprises a second set of heat exchangers, in which said second set of heat exchangers is arranged to:
i) receive a portion of: said first or second fuel gas stream, thereby generating a further cooled flue gas stream, and a preheated first fuel gas stream or a preheated second fuel gas stream; or
ii) receive a solvent solution, e.g. an amine-solution, from the CO2-absorber of said solvent wash unit, e.g. said amine wash unit, thereby generating further cooled flue gas stream and a preheated solvent-solution, e.g. a preheated amine-solution; or
iii) receive boiling feed water and/or demineralized water which is used in said plant for producing hydrogen, thereby generating further cooled flue gas stream as well as steam and/or preheated DMW; or
iv) receive the hydrocarbon feed, thereby generating further cooled flue gas stream as well as a preheated hydrocarbon feed.

7. The plant according to claim 6, wherein:
said second set of heat exchangers comprises one or more heat exchangers, suitably one heat exchanger, arranged downstream said first set of heat exchangers.

8. The plant according to claim 1, further comprising an additional CO2-removal section arranged to receive said cooled flue gas stream or said further cooled flue gas stream, thereby generating a second CO2-rich stream and a CO2-depleted flue gas stream, and in which said additional CO2-removal section also comprises a CO2-absorber under the addition of a solvent solution and a CO2-stripper for regenerating the solvent solution.

9. The plant according to claim 1, wherein the hydrogen purification unit is a pressure swing adsorption unit.

10. A process for producing hydrogen, comprising:
providing a plant according to claim 1;
conducting a primary reforming step of a hydrocarbon feed by supplying said hydrocarbon feed, to a primary reforming unit including a combustion section comprising a catalyst suitable for steam methane reforming and one or more burners for providing heat for said steam methane reforming, and conducting under the presence of steam said steam methane reforming for generating a first synthesis gas stream and a flue gas stream; said primary reforming unit also including a convection section comprising a first set of heat exchangers and cooling the flue gas stream in said first set of heat exchangers for generating a cooled flue gas stream;
optionally, conducting water gas shift by supplying the first synthesis gas to a shift section arranged to receive at least a portion of said first synthesis gas stream, said shift section suitably comprising a high temperature shift, for generating a second synthesis gas stream;
optionally, removing CO2 from the second synthesis gas by supplying the first or second synthesis gas stream to a CO2-removal section, the CO2-removal section being a chemical absorption unit where a solvent solution needs regeneration by heating, suitably a solvent wash unit, arranged to receive said first or second synthesis gas stream and comprising a CO2-absorber under the addition of the solvent solution, e.g. an amine solution, and regenerating the solvent solution 823), e.g. amine solution, in a CO2-stripper, for generating a third synthesis gas stream as well as a first CO2-rich stream;
supplying the first, or second, or third synthesis gas stream to a hydrogen purification unit, thereby generating a hydrogen-rich stream and an off-gas stream;
wherein the process further comprises:
supplying to said one or more burners a preheated combustion air stream;
supplying to said one or more burners a preheated first fuel gas stream or a preheated second fuel gas stream, in which the first fuel gas stream is a portion of said hydrogen-rich stream, and the second fuel gas stream is a gas stream resulting from combining at least a portion of said off-gas stream and said first fuel gas stream.

11. The process according to claim 10, wherein the process further comprises only supplying said first fuel gas stream or second fuel gas stream as fuel to said one or more burners.

12. The process according to claim 10, wherein:
said preheated combustion air stream, or said preheated first or second fuel gas stream, is generated by cooling the flue gas in: a heat exchanger of said first set of heat exchangers, and which is being supplied with a combustion air stream; or in a heat exchanger of said first set of heat exchangers which is being supplied with said first or second fuel gas stream.

13. The process according to claim 12, wherein the flue gas is cooled to below 100° C., for instance about 70° C.

14. The process according to claim 10, further comprising providing said convection section with a second set of heat exchangers, suitably a heat exchanger downstream said first set of heat exchangers, and:
i) supplying a portion of: said first or second fuel gas stream to the second set of heat exchangers, for generating a further cooled flue gas stream and said preheated first or second fuel gas stream, and feeding the preheated first or second fuel gas stream to said one or more burners of the primary reforming unit; or
ii) supplying a solvent solution, e.g. an amine-solution, from
the CO2-absorber of said solvent wash unit, e.g. amine wash unit, or
an additional CO2-removal section, suitably an additional solvent wash unit, arranged downstream said convection section of the primary reforming unit, to the second set of heat exchangers, for generating a further cooled flue gas stream and a preheated solvent solution, e.g. a preheated amine-solution; or
iii) supplying boiling feed water and/or demineralized water which is introduced into said process for producing hydrogen, and supplying BFW or DMW to the second set of heat exchangers, for generating a further cooled flue gas stream as well as preheated steam and/or preheated DMW, or
iv) supplying the hydrocarbon feed to the second set of heat exchangers, thereby generating a further cooled flue gas stream as well as a preheated hydrocarbon feed.

15. A method of retrofitting a plant for producing hydrogen,
said plant comprising a primary reforming unit for producing a synthesis gas stream, and a downstream hydrogen purification unit for producing a hydrogen-rich gas stream as said hydrogen and an off-gas stream; the primary reforming unit comprising: a combustion section comprising a catalyst suitable for steam methane reforming and one or more burners for providing heat for said steam methane reforming, for thereby generating said synthesis gas stream and a flue gas stream, and a convection section comprising a first set of heat exchangers for generating a cooled flue gas stream;
said downstream hydrogen purification unit being provided with an outlet for withdrawing the hydrogen-rich stream and an outlet for withdrawing the off-gas stream;
the method comprising:
installing in the convection section of the primary reforming unit a second set of heat exchangers, in which said second set of heat exchangers comprises one or more heat exchangers, suitably one heat exchanger, arranged downstream said first set of heat exchangers, thereby generating a further cooled flue gas stream;
installing a splitting point, for dividing a portion of said hydrogen-rich stream as a first fuel gas stream;
installing a mixing point, for combining at least a portion of said off-gas stream with said first fuel gas stream, thus forming a second fuel gas stream; and
installing a conduit for conducting said first fuel gas stream or said second fuel gas stream to the first and/or second set of heat exchangers and further to said one or more burners;
optionally, installing means for reducing or blocking the supply of a separate fuel gas stream to said one or more burners.

16. The method according to claim 15, wherein the plant further comprises a shift section and a CO2-removal section arranged between the primary reforming unit and hydrogen purification unit, the CO2-removal section being a chemical absorption unit where a solvent solution needs regeneration by heating, suitably a solvent wash unit,
the method of retrofitting further comprising:
installing an additional CO2-removal section arranged for receiving said cooled or further cooled flue gas stream.
